(19) United States
(12) Patent Application Publication
(10) Pub. No.: US 2025/0309815 A1
(43) Pub. Date: Oct. 2, 2025

(54) SOLAR PANEL MOUNTING ASSEMBLY

(71) Applicant: Johnathan O' Farrell, Phoenix, AZ (US)

(72) Inventor: Johnathan O' Farrell, Phoenix, AZ (US)

(21) Appl. No.: 18/620,029

(22) Filed: Mar. 28, 2024

(51) Int. Cl. H02S 20/23

(52) U.S. Cl. CPC H02S 20/23

(57) ABSTRACT

A solar panel mounting assembly includes a solar panel that is mountable on a roof of a building and a pair of rails each attached to the solar panel. A plurality of mounting plates is each removably attachable to a respective one of the pair of rails and each of the plurality of mounting plates lies against the roof of the building. A plurality of magnet units each includes a plurality of magnetic elements and each of the plurality of magnetic elements on a respective one of the plurality of magnet units is switchable between an actuated condition and a de-actuated condition. Each of the plurality of magnetic elements on a respective one of the plurality of magnet units is placed in magnetic communication with a respective one of the plurality of mounting plates to magnetically retain the solar panel on the roof.

### BACKGROUND OF THE INVENTION

### Field of the Invention

The disclosure relates to solar panel devices and more particularly pertains to a new solar panel device for mounting a solar panel to a roof without penetrating fasteners. The device includes a pair of rails mounted to a solar panel and a plurality of mounting plates attached to a respective rail; each of the plurality of mounting plates is positioned against the roof. The device includes a plurality of magnet units that are each positionable against an opposite side of the roof with respect to the mounting plates. Each of the plurality of magnet units magnetically engages a respective one of the plurality of mounting plates for magnetically retaining the solar panel on the roof.

### Description of Related Art Including Information Disclosed Under 37 CFR 1.97 and 1.98

The prior art relates to solar panel devices including a solar panel mounting device that includes an array of cables that are attachable to a roof to facilitate solar panels to be attached to the array of cables and a variety of solar panel mounting devices that each at least includes brackets that are attachable to a roof to facilitate solar panels to be attached to the brackets and a variety of solar panel mounting devices that each at least includes a magnet element integrated into a solar panel for magnetically engaging a support structure. In no instance does the prior art disclose a solar panel mounting device that includes a plurality of mounting plates that are each attachable to a solar panel and a plurality of magnet units that are each positionable against an opposite side of a roof with respect to the mounting plates for magnetically engaging the mounting plates thereby securing the solar panel to the roof.

### BRIEF SUMMARY OF THE INVENTION

An embodiment of the disclosure meets the needs presented above by generally comprising a solar panel that is mountable on a roof of a building and a pair of rails each attached to the solar panel. A plurality of mounting plates is each removably attachable to a respective one of the pair of rails and each of the plurality of mounting plates lies against the roof of the building. A plurality of magnet units each includes a plurality of magnetic elements and each of the plurality of magnetic elements on a respective one of the plurality of magnet units is switchable between an actuated condition and a de-actuated condition. Each of the plurality of magnetic elements on a respective one of the plurality of magnet units is placed in magnetic communication with a respective one of the plurality of mounting plates to magnetically retain the solar panel on the roof.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a solar panel mounting assembly according to an embodiment of the disclosure.

FIG. 2 is a back perspective view of a magnet unit of an embodiment of the disclosure.

FIG. 3 is a perspective view of a magnet unit of an embodiment of the disclosure.

FIG. 4 is a bottom view of magnet unit of an embodiment of the disclosure.

FIG. 5 is a bottom view of a mounting plate of an embodiment of the disclosure.

FIG. 6 is a bottom view of a mounting plate of an alternative embodiment of the disclosure.

FIG. 7 is a perspective view of a strike plate of an alternative embodiment of the disclosure.

FIG. 8 is a perspective in-use view of an embodiment of the disclosure showing a solar panel being mounted to a flat roof.

FIG. 9 is a perspective in-use view of an embodiment of the disclosure showing an alternative location for a magnet unit.

FIG. 10 is a perspective in-use view of an embodiment of the disclosure showing a magnet unit and a mounting plate being mounted to a flat roof that is comprised of corrugated metal.

FIG. 11 is a perspective in-use view of an embodiment of the disclosure showing a magnet unit and a mounting plate being mounted to a pitched roof that has shingles.

FIG. 12 is a perspective in-use view of an embodiment of the disclosure showing a solar panel being mounted to a roof of a building.

### DETAILED DESCRIPTION OF THE INVENTION

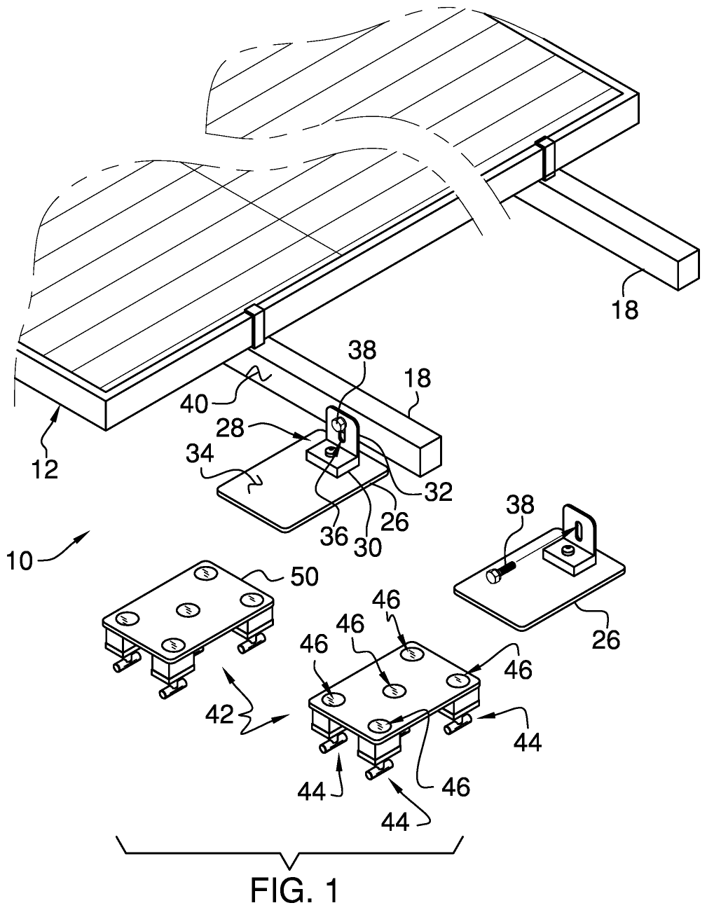

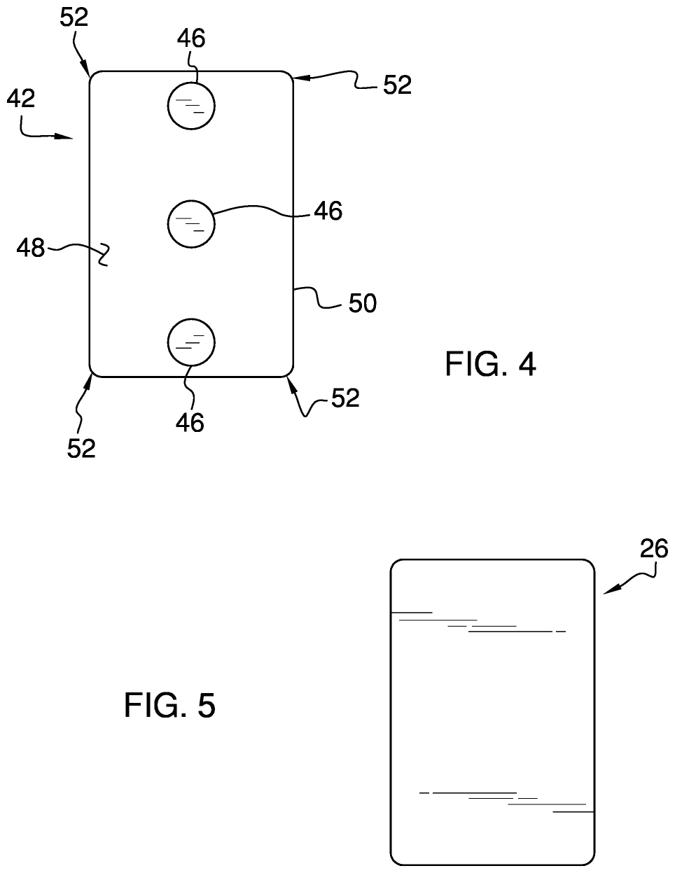

With reference now to the drawings, and in particular to FIGS. 1 through 12 thereof, a new solar panel device embodying the principles and concepts of an embodiment of the disclosure and generally designated by the reference numeral 10 will be described.

As best illustrated in FIGS. 1 through 12, the solar panel mounting assembly 10 generally comprises a solar panel 12 that is mountable on a roof 14 of a building 16 such that the solar panel 12 is exposed to sunlight. The solar panel 12 may be a solar panel of any conventional design that is commonly employed in residential applications for generating solar power and the building 16 may be a house, an apartment building or any other type of occupancy. A pair of rails 18 is provided and each of the pair of rails 18 is attached to the solar panel 12. Each of the pair of rails 18 is mounted to a bottom surface 20 of the solar panel 12 and each of the pair of rails 18 is elongated to extend outwardly beyond each of a first lateral edge 22 and a second lateral edge 24 of the solar panel 12.

A plurality of mounting plates 26 is provided and each of the plurality of mounting plates 26 is removably attachable to a respective one of the pair of rails 18. Furthermore, each of the plurality of mounting plates 26 can be positioned to lie against the roof 14 of the building 16 having the solar panel 12 being spaced from the roof 14. Additionally, each of the plurality of mounting plates 26 is comprised of a ferromagnetic material. Each of the plurality of mounting plates 26 includes a mount 28 which comprises a first bracket 30 that is perpendicular to a second bracket 32. The first bracket 30 is attached to an upper surface 34 of a respective mounting plate 26 having the second bracket 32 extending upwardly from the respective mounting plate 26. Additionally, the mount 28 on each of the plurality of mounting plates 26 has a slot 36 extending through the second bracket 32.

A plurality of fasteners 38 is provided and each of the plurality of fasteners 38 may comprise a bolt, a screw or other type of threaded fastener. Each of the plurality of fasteners 38 extends through the slot 36 in the second bracket 32 of the mount 28 on a respective one of the plurality of mounting plates 26 and engages a lateral surface 40 of a respective one of the pair of rails 18 for mounting the respective mounting plate 26 to the respective rail 18. The slot 36 in the second bracket 32 of the mount 28 of each of the plurality of mounting plates 26 is elongated to extend along a substantial length of the second bracket 32. In this way the fastener 38 which extends through the slot 36 can move upwardly and downwardly in the slot 36 for adjusting a distance between the respective mounting plate 26 and the respective rail 18.

A plurality of magnet units 42 is provided and each of the plurality of magnet units 42 includes a plurality of levers 44 and a plurality of magnetic elements 46 each is in communication with a respective one of the plurality of levers 44. Each of the plurality of magnetic elements 46 on a respective one of the plurality of magnet units 42 is switchable between an actuated condition and a de-actuated condition when a respective one of the plurality of levers 44 is rotated between an actuating position and a de-actuating position. Furthermore, each of the plurality of magnetic elements 46 on each of the plurality of magnet units 42 is oriented to be coplanar with each other. In this way the plurality of magnetic elements 46 on each of the plurality of magnet units 42 can abut an opposing side of the roof 14 with respect to the plurality of mounting plates 26.

Each of the plurality of magnetic elements 46 on a respective one of the plurality of magnet units 42 is placed in magnetic communication with a respective one of the plurality of mounting plates 26 when the plurality of levers 44 on the respective magnet unit 42 are rotated into the actuating position. In this way each of the plurality of magnet units 42 and each of the plurality of mounting plates 26 magnetically retain the solar panel 12 on the roof 14. Each of the plurality of magnetic elements 46 on the respective magnet unit 42 is inhibited from being in magnetic communication with the respective mounting plate 26 when the plurality of levers 44 on the respective magnet unit 42 are rotated into the de-actuating position. In this way each of the plurality of magnet units 42 and each of the plurality of mounting plates 26 facilitate the solar panel 12 to be removed from the roof 14.

Each of the plurality of magnetic elements 46 of a respective one of the plurality of magnet units 42 is integrated into a top surface 48 of a magnet plate 50 of the respective magnet unit 42 such that the plurality of magnetic elements 46 is oriented flush with the top surface 48. Additionally, the plurality of magnetic elements 46 on the magnet plate 50 of the respective magnet unit 42 is strategically arranged on the magnet plate 50 of the respective magnet unit 42. As is shown in FIG. 1, respective ones of the plurality of magnetic elements 46 may be aligned with a respective one of four corners 52 of the magnet plate 50 and a respective one of the plurality of magnetic elements 46 may be centrally located on the magnet plate 50 such that the plurality of magnetic elements 46 defines a quincunx shape. As is shown in FIG. 3, the plurality of magnetic elements 46 may be arranged in a straight line extend across the top surface 48 of the magnet plate 50.

Each of the plurality of plurality of magnet units 42 includes a plurality of housings 54 each mounted to a bottom surface 56 of the magnet plate 50 of a respective magnet unit 42. Additionally, each of the plurality of housings 54 is aligned with a respective one of the plurality of magnetic elements 46 of the respective magnet unit 42. Each of the plurality of levers 44 comprises a first shaft 58 and a second shaft 60 that is perpendicular to the first shaft 58. The first shaft 58 of each of the plurality of levers 44 of a respective one of the plurality magnet units 42 is rotatably integrated into a bottom wall 62 of a respective one of the plurality of housings 54 on the bottom surface 56 of the magnet plate 50 of the respective magnet unit 42. Additionally, the second shaft 60 of each of the plurality of levers 44 can be gripped for rotating the levers 44 between the actuated position and the de-actuated position.

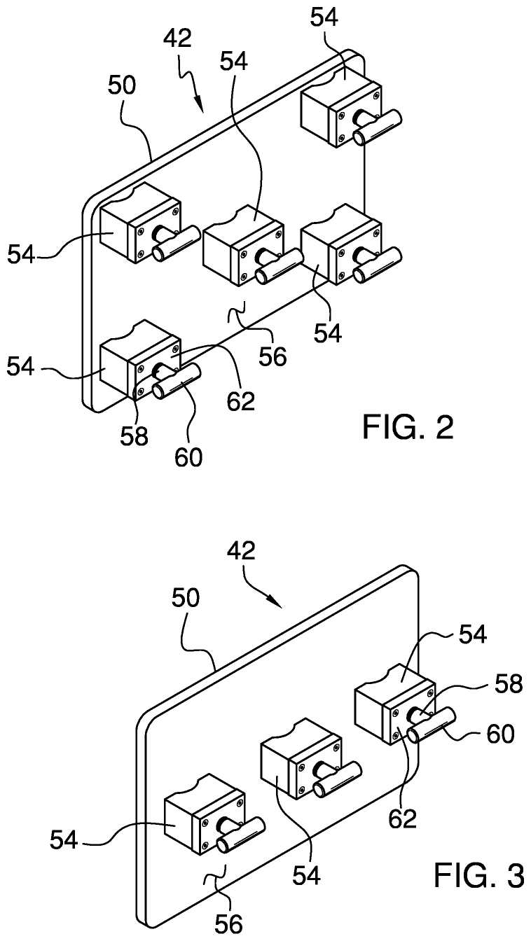

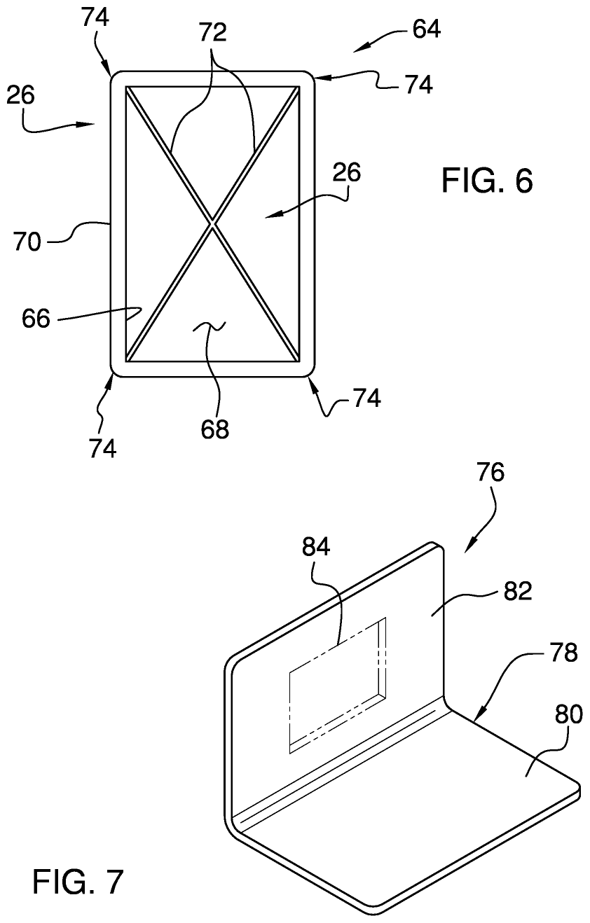

As is shown in FIGS. 1 and 2, the plurality of housings 54 may be arranged to define a quincunx shape. As is shown in FIG. 3, the plurality of housings 54 may be arranged to define a straight line. In an alternative embodiment 64 shown in FIG. 6, each of the plurality of mounting plates 26 includes a border 66 that is attached to a lower surface 68 of a respective mounting plate 26 having the border 66 being coextensive with a perimeter edge 70 of the respective mounting plate 26. The border 66 is comprised of a ferromagnetic material thereby facilitating the border 66 to be magnetically engaged by a respective magnet unit 42. Continuing in the alternative embodiment 64, each of the plurality of mounting plates 26 includes a pair of cross members 72 that are attached to the lower surface 68 of the respective mounting plate 26. Each of the pair of cross members 72 is oriented to extend between a respective pair of four corners 74 of the border 66 such that the pair of cross members 72 defines an X. Additionally, each of the pair of cross members 72 is comprised of a ferromagnetic material thereby facilitating each of the pair of cross members 72 to be magnetically engaged by the respective magnet unit 42.

In an alternative embodiment 76 shown in FIG. 7, a strike plate 78 is included that has a first portion 80 of the strike plate 78 which is perpendicular to a second portion 82 of the strike plate 78. Additionally, the first portion 80 of the strike plate 78 is comprised of a ferromagnetic material. The first portion 80 of the strike plate 78 is positionable between a respective one of the plurality of mounting plates 26 and the roof 14 having the second portion 82 being vertically oriented. In this way the second portion 82 can be struck with a tool, such as a hammer for example, thereby dislodging the respective mounting plate 26 from the roof 14. The strike plate 78 may have an opening 84 extending through the second portion 82 to facilitate a pry bar, for example, to be extended through the opening 84 for subsequently dislodging the respective mounting plate 26 from the roof 14.

In use, one or more first workers positions the solar panel 12 at a desired location on the roof 14 such that each of the mounting plates 26 rests against an outwardly facing surface 86 of the roof 14. One or more second workers places each of the magnet units 42 against an inwardly facing surface 88 of the roof 14 such that each of the magnet units 42 is aligned with a respective one of the mounting plates 26. Each of the plurality of levers 44 on each of the plurality of magnet units 42 is rotated into the actuated position thereby facilitating each of the magnetic elements 46 on each of the plurality of magnet units 42 to magnetically engage the respective mounting plate 26. In this way the solar panel 12 can be mounted to the roof 14 without the use of penetrating fasteners thereby preserving the integrity of the roof 14 against wind and precipitation. Each of the plurality of levers 44 on each of the plurality of magnet units 42 is rotated into the de-actuated position to inhibit the plurality of magnet units 42 from magnetically engaging the respective mounting plate 26. In this way the solar panel 12 can be removed from the roof 14.

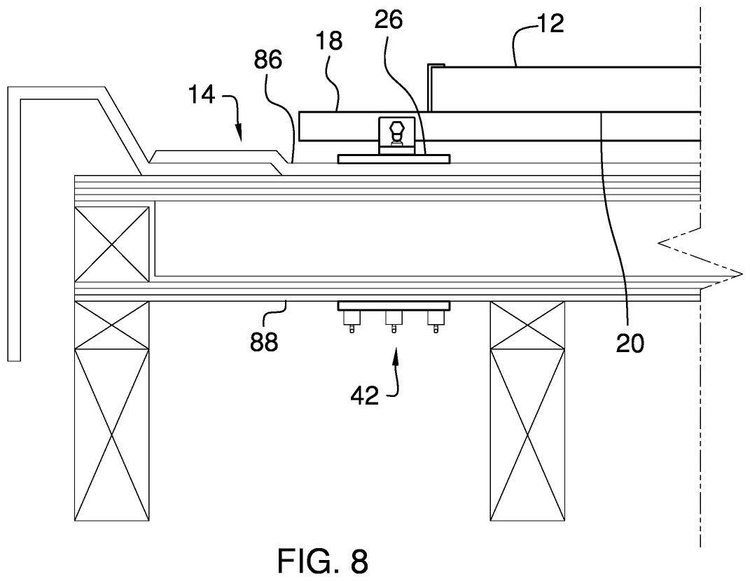

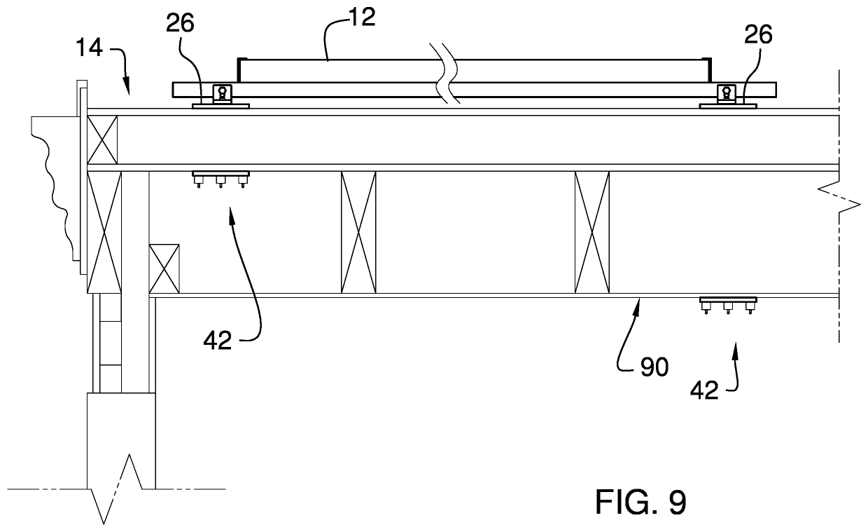

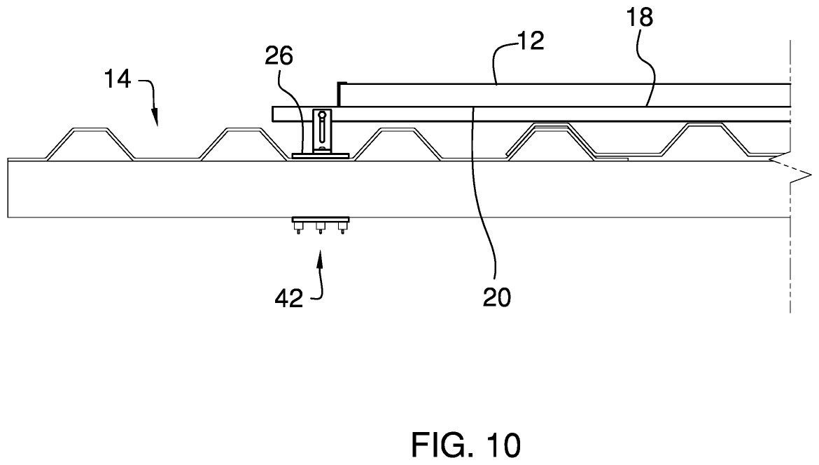

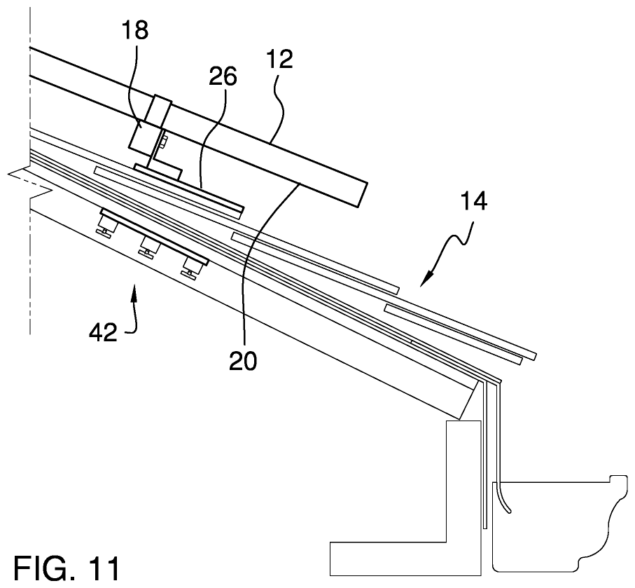

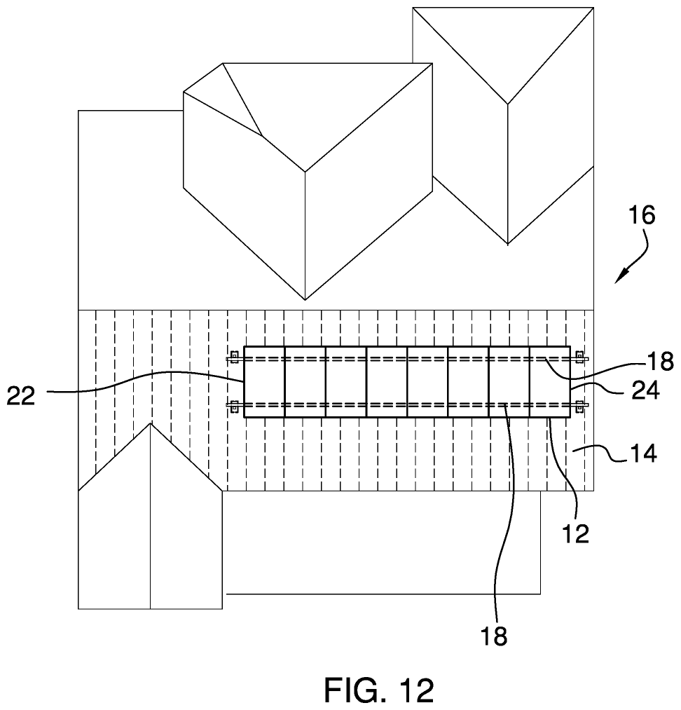

FIG. 8 shows a magnet unit 42 and a mounting plate 26 being mounted to a flat roof 14 and FIG. 9 shows a potentially alternative location for the magnet units 42 which shows a magnet unit 42 positioned on a girder 90 of the roof 14. FIG. 10 shows a magnet unit 42 and a mounting plate 26 being mounted to a flat roof 14 that is comprised of corrugated metal. FIG. 11 shows a magnet unit 42 and a mounting plate 26 being mounted to a pitched roof 14 that has shingles. FIG. 12 is a perspective view that shows the solar panel 12 mounted to the roof 12 of the building 16.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A solar panel mounting assembly for securing a solar panel to a roof of a structure without the use of penetrating fasteners, said assembly comprising:
a solar panel being mountable on a roof of a building wherein said solar panel is configured to be exposed to sunlight;
a pair of rails, each of said pair of rails being attached to said solar panel;
a plurality of mounting plates, each of said plurality of mounting plates being removably attachable to a respective one of said pair of rails wherein each of said plurality of mounting plates is configured to lie against the roof of the building having said solar panel being spaced from the roof, each of said plurality of mounting plates being comprised of a ferromagnetic material; and
a plurality of magnet units, each of said plurality of magnet units including a plurality of levers and a plurality of magnetic elements each being in communication with a respective one of said plurality of levers, each of said plurality of magnetic elements on a respective one of said plurality of magnet units being switchable between an actuated condition and a de-actuated condition when a respective one of said plurality of levers is rotated between an actuating position and a de-actuating position, each of said plurality of magnetic elements on each of said plurality of magnet units being oriented to be coplanar with each other wherein said plurality of magnetic elements on each of said plurality of magnet units is configured to abut an opposing side of the roof with respect to said plurality of mounting plates, each of said plurality of magnetic elements on a respective one of said plurality of magnet units being placed in magnetic communication with a respective one of said plurality of mounting plates when said plurality of levers on said respective magnet unit are rotated into said actuating position wherein each of said plurality of magnet units and each of said plurality of mounting plates are configured to magnetically retain said solar panel on the roof, each of said plurality of magnetic elements on said respective magnet unit being inhibited from being in magnetic communication with said respective mounting plate when said plurality of levers on said respective magnet unit are rotated into said de-actuating position wherein each of said plurality of magnet units and each of said plurality of mounting plates is configured to facilitate said solar panel to be removed from the roof.

2. The assembly according to claim 1, wherein:
each of said pair of rails being mounted to a bottom surface of said solar panel;
each of said pair of rails is elongated to extend outwardly beyond each of a first lateral edge and a second lateral edge of said solar panel;
each of said plurality of mounting plates includes a mount which comprises a first bracket being perpendicular to a second bracket;
said first bracket is attached to an upper surface of a respective mounting plate having said second bracket extending upwardly from said respective mounting plate;
said mount on each of said plurality of mounting plates has a slot extending through said second bracket;
said assembly includes a plurality of fasteners;
each of said plurality of fasteners extends through said slot in said second bracket of said mount on a respective one of said plurality of mounting plates and engages a lateral surface of a respective one of said pair of rails for mounting said respective mounting plate to said respective rail; and
said slot in said second bracket of said mount of each of said plurality of mounting plates is elongated to extend along a substantial length of said second bracket thereby facilitating said fastener which extends through said slot to move upwardly and downwardly in said slot for adjusting a distance between said respective mounting plate and said respective rail.

3. The assembly according to claim 1, wherein:
each of said plurality of magnetic elements of a respective one of said plurality of magnet units is integrated into a top surface of a magnet plate of said respective magnet unit such that said plurality of magnetic elements is oriented flush with said top surface;
said plurality of magnet elements on said magnet plate of said respective magnet unit are strategically arranged on said magnet plate of said respective magnet unit.

4. The assembly according to claim 3, wherein:
each of said plurality of plurality of magnet units includes a plurality of housings each being mounted to a bottom surface of said magnet plate of a respective magnet unit; and
each of said plurality of housings is aligned with a respective one of said plurality of magnetic elements of said respective magnet unit.

5. The assembly according to claim 4, wherein:
each of said plurality of levers comprises a first shaft and a second shaft being perpendicular to said first shaft; and
said first shaft of each of said plurality of levers of a respective one of said plurality magnet units is rotatably integrated into a bottom wall of a respective one of said plurality of housings on said bottom surface of said magnet plate of said respective magnet unit wherein said second shaft of each of said plurality of levers is configured to be gripped for rotating said levers between said actuated position and said de-actuated position.

6. A solar panel mounting assembly for securing a solar panel to a roof of a structure without the use of penetrating fasteners, said assembly comprising:
a solar panel being mountable on a roof of a building wherein said solar panel is configured to be exposed to sunlight;
a pair of rails, each of said pair of rails being attached to said solar panel, each of said pair of rails being mounted to a bottom surface of said solar panel, each of said pair of rails being elongated to extend outwardly beyond each of a first lateral edge and a second lateral edge of said solar panel;
a plurality of mounting plates, each of said plurality of mounting plates being removably attachable to a respective one of said pair of rails wherein each of said plurality of mounting plates is configured to lie against the roof of the building having said solar panel being spaced from the roof, each of said plurality of mounting plates being comprised of a ferromagnetic material, each of said plurality of mounting plates including a mount which comprises a first bracket being perpendicular to a second bracket, said first bracket being attached to an upper surface of a respective mounting plate having said second bracket extending upwardly from said respective mounting plate, said mount on each of said plurality of mounting plates having a slot extending through said second bracket;
a plurality of fasteners, each of said plurality of fasteners extending through said slot in said second bracket of said mount on a respective one of said plurality of mounting plates and engaging a lateral surface of a respective one of said pair of rails for mounting said respective mounting plate to said respective rail, said slot in said second bracket of said mount of each of said plurality of mounting plates being elongated to extend along a substantial length of said second bracket thereby facilitating said fastener which extends through said slot to move upwardly and downwardly in said slot for adjusting a distance between said respective mounting plate and said respective rail; and
a plurality of magnet units, each of said plurality of magnet units including a plurality of levers and a plurality of magnetic elements each being in communication with a respective one of said plurality of levers, each of said plurality of magnetic elements on a respective one of said plurality of magnet units being switchable between an actuated condition and a de-actuated condition when a respective one of said plurality of levers is rotated between an actuating position and a de-actuating position, each of said plurality of magnetic elements on each of said plurality of magnet units being oriented to be coplanar with each other wherein said plurality of magnetic elements on each of said plurality of magnet units is configured to abut an opposing side of the roof with respect to said plurality of mounting plates, each of said plurality of magnetic elements on a respective one of said plurality of magnet units being placed in magnetic communication with a respective one of said plurality of mounting plates when said plurality of levers on said respective magnet unit are rotated into said actuating position wherein each of said plurality of magnet units and each of said plurality of mounting plates are configured to magnetically retain said solar panel on the roof, each of said plurality of magnetic elements on said respective magnet unit being inhibited from being in magnetic communication with said respective mounting plate when said plurality of levers on said respective magnet unit are rotated into said de-actuating position wherein each of said plurality of magnet units and each of said plurality of mounting plates is configured to facilitate said solar panel to be removed from the roof, each of said plurality of magnetic elements of a respective one of said plurality of magnet units being integrated into a top surface of a magnet plate of said respective magnet unit such that said plurality of magnetic elements is oriented flush with said top surface, said plurality of magnet elements on said magnet plate of said respective magnet unit being strategically arranged on said magnet plate of said respective magnet unit, each of said plurality of plurality of magnet units including a plurality of housings each being mounted to a bottom surface of said magnet plate of a respective magnet unit, each of said plurality of housings being aligned with a respective one of said plurality of magnetic elements of said respective magnet unit, each of said plurality of levers comprising a first shaft and a second shaft being perpendicular to said first shaft, said first shaft of each of said plurality of levers of a respective one of said plurality magnet units being rotatably integrated into a bottom wall of a respective one of said plurality of housings on said bottom surface of said magnet plate of said respective magnet unit wherein said second shaft of each of said plurality of levers is configured to be gripped for rotating said levers between said actuated position and said de-actuated position.

7. The assembly according to claim 6, wherein:
each of said plurality of mounting plates includes a border being attached to a lower surface of a respective mounting plate having said border being coextensive with a perimeter edge of said respective mounting plate;
said border being comprised of a ferromagnetic material wherein said border is configured to be magnetically engaged by a respective magnet unit;
each of said plurality of mounting plates includes a pair of cross members being attached to said lower surface of said respective mounting plate;
each of said pair of cross members is oriented to extend between a respective pair of four corners of said border such that said pair of cross members defines an X; and
each of said pair of cross members is comprised of a ferromagnetic material wherein each of said pair of cross members is configured to be magnetically engaged by said respective magnet unit.

8. The assembly according to claim 6, wherein:
said assembly includes a strike plate having a first portion of said strike plate being perpendicular to a second portion of said strike plate;
said first portion of said strike plate is comprised of a ferromagnetic material; and
said first portion of said strike plate being positionable between a respective one of said plurality of mounting plates and the roof having said second portion being vertically oriented wherein said second portion is configured to be struck with a tool thereby dislodging said respective mounting plate from the roof.
